(19) United States
(12) Patent Application Publication
(10) Pub. No.: US 2009/0006519 A1
(43) Pub. Date: Jan. 1, 2009

(54) Managing a computing environment

(75) Inventors: Durgesh Nandan, Redmond, WA (US); Shuyi Hu, Bothell, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/824,505

(22) Filed: Jun. 29, 2007

(51) Int. Cl. G06F 15/177

(52) U.S. Cl. 709/200

(57) ABSTRACT

Embodiments are provided to configure a number of computing devices based in part on a number of deployment parameters and functions, but the embodiments are not so limited. In an embodiment, a managing application can be used to define a deployment blueprint which includes a number of deployment parameters and functions associated with the configuration of a number of computing devices. The managing application can be used to define a deployment blueprint that includes a number of computing devices, including virtual devices, logical devices, and other devices, systems, and components. Other embodiments are available.

### RELATED APPLICATIONS

This application is related to U.S. patent application Ser. No. ______, filed Jul. ______, 2007, and entitled, “MANAGING A DEPLOYMENT OF A COMPUTING ARCHITECTURE,” having docket number 14917.0636US01 which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### BACKGROUND

Reference models and blueprints are useful for building and recreating reliable computing architectures. For example, a blueprint can be used to configure hardware and software components for an enterprise computing environment. A reliable blueprint can be used to build secure architectures which can include network, server, and storage functionality. However, some blueprints can be unreliable and contradictory. For example, a blueprint may designate a particular hardware configuration for a server that is incompatible with a particular purpose. Human error can compound the issue. For example, a number of administrators and associated support personnel may be tasked to manually deploy aspects of an enterprise system in accordance with a particular blueprint. The configuration and deployment can take hours (and often days), and may include starting the process over when a blueprint is misinterpreted or otherwise mismanaged. Correspondingly, a deployment process using an unreliable blueprint can end up being inefficient and costly for an enterprise or other organization.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided to configure a number of computing devices based in part on a number of deployment parameters, but the embodiments are not so limited. In an embodiment, a managing application can be used to define a deployment blueprint which includes a number of deployment parameters and functions associated with the configuration of a number of computing devices. The managing application can be used to define a deployment blueprint that includes a number of computing devices, including virtual devices, logical devices, and other devices and systems.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 depicts a block diagram of a computing environment.

FIG. 2 is a flow diagram illustrating creating a deployment blueprint associated with the configuration of a number of devices.

FIG. 3 is a block diagram illustrating a computing environment for implementation of various embodiments described herein.

### DETAILED DESCRIPTION

Embodiments are provided to configure a number of computing devices based in part on a number of deployment requirements. In an embodiment, a manager component can be used to define a deployment blueprint that includes a number of deployment parameters and functions associated with the configuration of a number of computing devices. The deployment parameters can include configuration details, including a number of deployment steps associated with a particular deployment. A defined blueprint can be used to quickly, efficiently, and reliably deploy computing devices for testing, debugging, and other purposes.

In one embodiment, a managing application can be configured as a software program and used to define a deployment blueprint for a computing architecture. A deployment blueprint can include a number of computing devices and associated configurations, including virtual devices, logical devices, and other devices, which can be deployed according to the defined blueprint. For example, the managing application can be used to configure a cluster of servers according to a defined deployment environment associated with a deployment blueprint.

The managing application can be used to define a blueprint to include a number of deployment parameters including, but not limited to: computing device names; deployment packages; computing device roles; dependencies; sequences; certificates; configuration information; port and wires; etc. For example, multiple sequences can be defined for a particular deployment, wherein each sequence may contain a set of computing devices with a deployment order number. All sequences can be executed in parallel, wherein machines defined as part of a sequence can be deployed in a particular order.

In another embodiment, a managing application can be used to define a deployment blueprint which comprises a number of defined parameters and functions in an extensible markup language (XML). For example, an XML file can be used to define a blueprint which includes a number of deployment parameters and functions associated with a deployment cluster. The XML file can include device names, packages to be deployed on associated devices, device roles, configuration information, dependencies, sequences, certificate information, ports/wires, etc. The XML file can be used to efficiently deploy and/or reconfigure a computing architecture.

For example, a user can use the managing application to: create a blueprint of a logical cluster, edit/view existing blueprints, suggest corrective actions, take corrective actions, validate packages, and perform other deployment actions. The managing application also allows for federating schema management and propagating schema changes in a quick and efficient manner since schema related updates can be centralized by using an XML-based deployment file (e.g., machine XML). The managing application can include an associated schema that is compatible with service modeling language (SML) and other schema types. In one embodiment, an XML-based schema can be used to transition to an SML-based schema, thereby providing an avenue for integration with a dynamic systems initiative (DSI), such as when defining a design state of a data center for example. Accordingly, an SML-based deployment file can be derived from an XML-based deployment file by using an XML-based schema to transition to an SML-based schema.

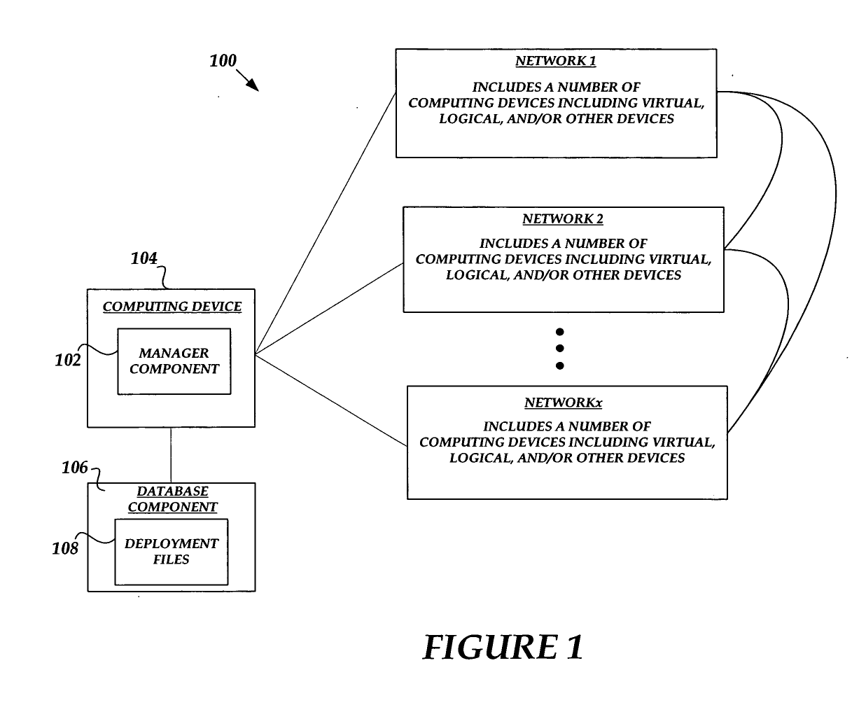

FIG. 1 depicts a computing environment 100, under an embodiment. As described below, a manager component 102 can be used to manage aspects of the computing environment 100, including defining a deployment blueprint for deploying a number of computing devices associated with the computing environment 100 and other computing devices and/or computing networks. The manager component 102 can be executed from an associated computing device 104 and used to interact with a number of computing devices that may be included as part of a defined deployment blueprint. The manager component 102 can also be executed as part of a web-based service using the computing device 104. For example, the manager component 102 can be used to interact with other computing devices and networks, as part of a wired, wireless, and/or combination of communication configurations.

As used herein, computing device is not intended to be limiting and can refer to any computing device, system, or component, including servers, desktops, handhelds, laptops, software implementations, logical devices, virtual devices, and other computing devices and systems. A logical device can refer to a number of devices or systems which can be grouped as a cluster, wherein one cluster can be defined as a deployment unit. Thus, an XML-based deployment file can be associated with each deployment unit. For example, for a domain of 100 computing devices, a user can create 10 clusters having 10 corresponding XML-based deployment files.

Devices in each cluster can be described as logical devices even though they may be coupled on a LAN and domain. Virtual devices can refer to devices or systems that are expecting or configured to accept a type of package. Virtual devices that are expecting the same type of package(s) can be grouped together to define one unit for deployment. As such, one plan can be defined for each unit, including an incorporating an associated audit for each unit. As used herein, the term “network” encompasses any configuration of computing devices which are transferring and manipulating information and can be implemented as a wired network, a wireless network, a combination of a wired and a wireless network, and/or other types of communication networks. While FIG. 1 depicts a networked configuration, other configurations are available.

As shown in FIG. 1, the computing environment 100 includes a network 1, a network 2, and a networkₓ (where x is some integer). Each network can include any number of computing devices and networking elements. The computing environment 100 also includes a number of computing devices D1-Dₓ (where x is some integer) that may or may not be associated with a particular network. For example, network I may represent a first number of servers associated with a first serving pool and network 2 may represent a second number of servers associated with a second serving pool. Continuing with the example, the manager component 102 can be used to designate any number of computing devices associated with the first serving pool, the second serving pool, and/or a number of computing devices D1-Dₓ when defining a deployment blueprint.

The manager component 102 is configured to provide a consistent user experience when creating and maintaining deployment blueprints. A user can use the manager component 102 to easily and quickly create, update, and otherwise interact with deployment blueprints. For example, the manager component 102 can be used to create, update, and maintain a deployment blueprint corresponding to a cluster of serving computing devices. As further example, the manager component 102 can be used to define a particular blueprint that may include 20 computing devices associated with a data center. Out of the 20 computing devices, the manager component 102 can be used to designate 10 computing devices as front-end web servers, 5 computing devices as database servers, 3 computing devices as search servers, and reserve the remaining 2 computing devices for an application to be determined.

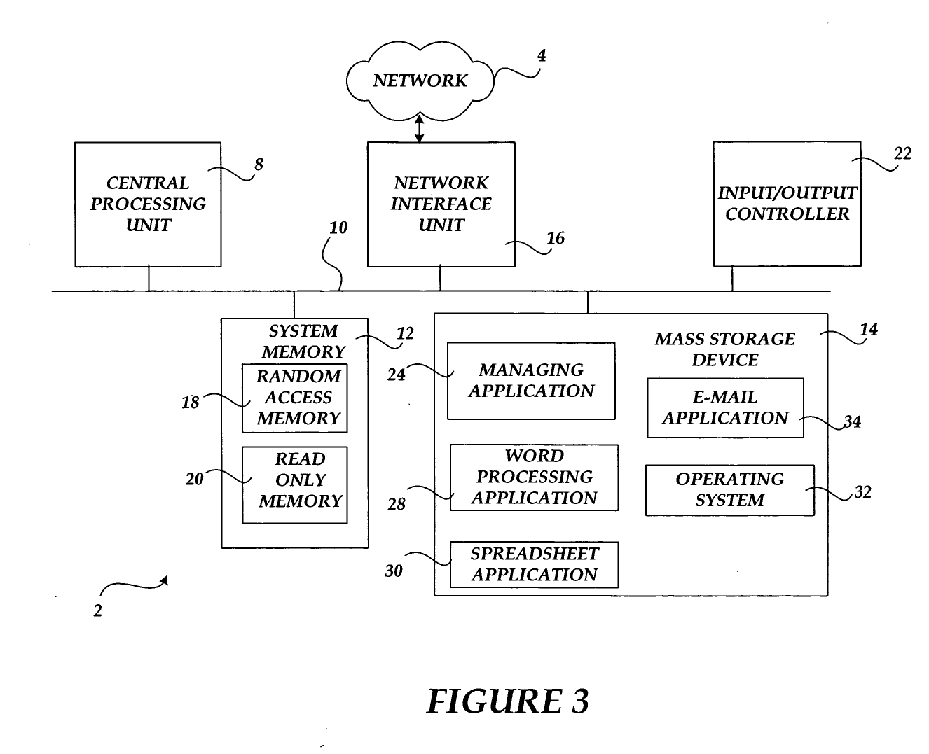

In one embodiment, the manager component 102 can be configured as a software application (see FIG. 3, managing application 24) and can be employed on a client device for use in the deployment of computing devices according to a defined deployment blueprint. As described below, the manager component 102 can be used to create and maintain an XML-based deployment file associated with a blueprint. The XML-based deployment file can be used to deploy a number of computing devices according a defined deployment blueprint. For example, a user can use the manager component 102 to create an XML-based deployment file, including identifying computing devices, packages, certificates, etc. to include as part of a deployment blueprint. The XML-based deployment file can also be accessed to determine the number of computing devices associated with a deployment, the configuration of each computing device, the software package(s) associated with each computing device, etc.

In an embodiment, the manager component 102 can be configured as a user interface (UI) and accessed using a computing device 104. The manager component 104 can be accessed locally or remotely. Correspondingly, a user can use the manager component 102 configured as a UI to interactively define a deployment blueprint, such as a deployment blueprint for a testing cluster or debugging a cluster for example. In one embodiment, the UI can be configured as part of a web-based service that users can access after providing proper authentication credentials. The UI can be configured to present deployment parameters to a user in different ways. For example, the UI can be configured to provide a graphical blueprint view which allows a user to drag and drop (or cut and paste) packages, computing devices, and other infrastructure as part of an interaction with a deployment blueprint.

As described briefly above, the manager component 102 can be used to create an XML-based deployment file that can include a number of deployment parameters. For example, a user can create an XML-based deployment file for a test cluster, wherein the XML-based deployment file identifies: a number of computing devices to be used for testing; software packages to be included on each computing device; and, certificates to use during various testing operations. The manager component 102 is further configured to enable a user to open, view, and validate XML-based deployment files. For example, a user can use the manager component 102 to validate an XML-based deployment file associated with a number of rule and/or schema changes.

The manager component 102 can also be configured to suggest corrective actions when an XML-based deployment file is determined to be invalid or otherwise defective in some way. Thereafter, the manager component 102 can be used to automatically take corrective actions when an XML-based deployment file is found to be invalid or defective. For example, certain procedures can be employed to control a check-in and check-out process associated with the use of an XML-based deployment file to control valid access credentials.

As part of a check-in and check-out process, the managing component 102 can use a centralized repository for versioned files (e.g., Source Depot (SD). Each XML-based deployment machine can be stored in centralized repository and checked out for updates. For example, certain users may have check-in and check-out permissions while others do not. In certain situations, the manager component 102 can be used to prevent a user or users from manually updating or changing an XML-based deployment file. The manager component 102 can also be used to include versioning and/or historical information as part of the maintenance of an XML-based deployment file. For example, the XML-based deployment file can include information associated with users who have opened and edited an associated deployment blueprint.

The manager component 102 can be used with computing devices (e.g. data center serving computers) which may include different hardware and/or software configurations. For example, servers can include different hardware and software configurations based on a deployment type. As further example, SQL servers typically have larger hard drives as compared to web servers. The different hardware configurations can require different configurations during setup, such as partition settings for example. Accordingly, in one embodiment, the manager component 102 can be used to create a deployment blueprint based in part on defined component types. For example, common server types include SQL servers, Content servers, and web servers. Middle tier components can also be defined according to a configuration type (e.g., hosted service type) for an associated blueprint.

The manager component 102 can further be used to define a type of platform software to be installed on an associated computing device. The manager component 102 can also define a number of functions to be associated with a computing device. For example a user can use the manager component 102 to define a number of functions which are used when deploying one or more computing devices that include, but are not limited to: front-end server for a web service (with or without authentication); front-end server for a redirect service (including client/server redirect); front-end server for a research and reference service; back-end database server (e.g., SQL server); content server; a search server; a web server for certain tools (e.g., IPO tools); etc.

With continuing reference to FIG. 1, a database component 106 can be associated and in communication with the manager component 102. The database component 106 may be co-located or remotely located. The database component 106 or other repository (e.g., file server(s)) can be used to store information associated with a deployment blueprint and/or users associated therewith. In one embodiment, the database component 106 includes a number of deployment files 108, such as a number of XML-based deployment files for example. For example, a stored deployment blueprint in the form of an XML-based deployment file can be called or otherwise accessed from the database component 106 when deploying a particular computing architecture, such as for a cluster of computing devices.

The database component 106 can also include a dynamic link library (dll) that includes the functions that are associated with a deployment file. For example, a deployment or dispatch component can access these functions from the dll file when deploying a number of computing devices according to a particular blueprint defined by an XML-based deployment file. The database component 106 can also include information associated with: reservation status; deployment status; availability status; access credentials; authentication information; etc. In one embodiment, the database component 106 can also include the location (e.g., stored as a path, etc.) of an associated XML-based deployment file and any associated shipment files, if available.

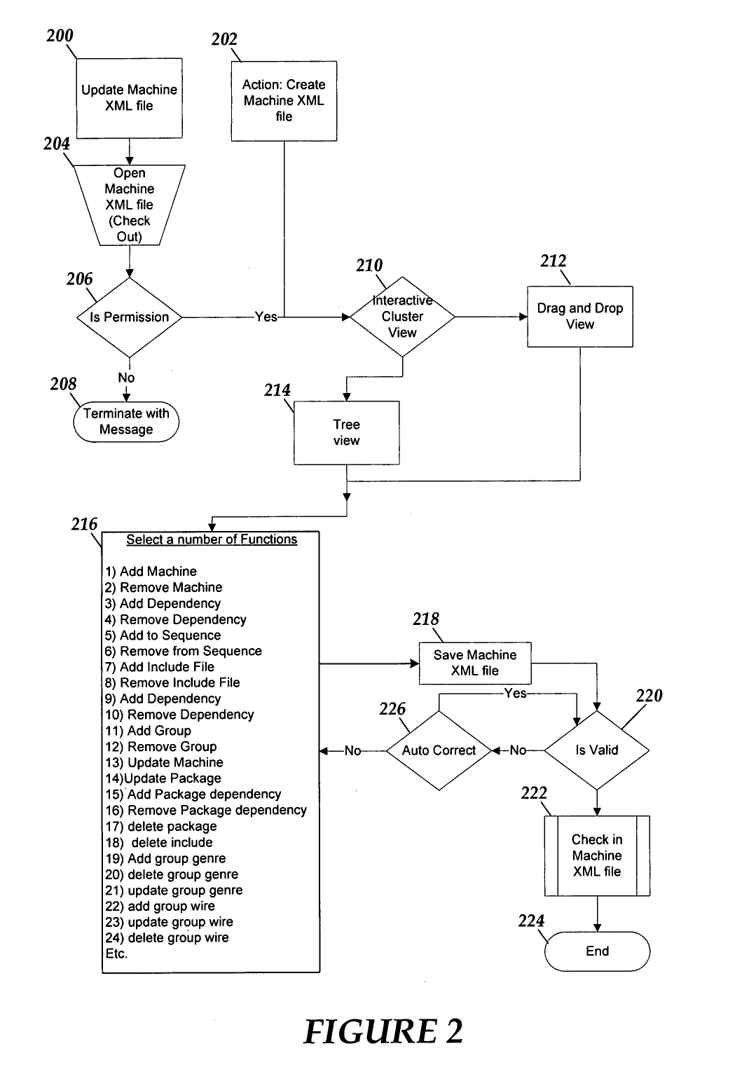

Referring now to FIG. 2, a flow diagram illustrates using a managing application (such as managing application 24 of FIG. 3) to create a deployment blueprint for a computing architecture, under an embodiment. In one embodiment, a deployment blueprint is configured as an XML-based deployment file that includes a number of deployment parameters associated with the particular blueprint. The term “machine” includes physical computing devices, logical computing devices, virtual computing device, and other devices, systems, software configurations, and logical components.

As shown in FIG. 2, the flow can begin from 200 and 202, but is not so limited. At 200, a user can use the managing application to update a deployment blueprint for an associated computing architecture. As shown in FIG. 2, the deployment blueprint file is referred to as a Machine XML file. The Machine XML file may be stored locally or remotely and accessed accordingly. In one embodiment, the Machine XML file defines a number of deployment parameters and functions that are associated with a defined blueprint. The Machine XML file can include parameters associated with a number of defined elements, attributes, values, etc. The Machine XML file can be used as a blueprint when deploying a number of computing devices according to a defined computing architecture.

At 204, the user can use the managing application to locate and open (also referred to as check-out) the associated Machine XML file. For example, the managing application can present a number of Machine XML files to the user, where certain Machine XML files are accessible (have permissions) and others are not (no permissions). At 206, the managing application checks to see whether the user has the proper access permissions to update the Machine XML file. For example, the managing application can compare a user's credentials to credentials stored in a database or other repository to determine access permissions.

If the user does not have permission to update the Machine XML file, at 208 the managing application operates to terminate the update session with an error message that informs the user that access is not permitted based on the user credentials or other permission parameters. Alternatively, the user may view the Machine XML file as “read-only.” If the user does have permission to update the Machine XML file, the flow proceeds to 210, described below.

A user can also use the managing application to create a deployment blueprint (e.g., Machine XML file) for an associated computing architecture at 202. At 210, the user (from 206 as well) can select from two different interactive views using the managing application. At 212, the user has opted to use a “drag and drop” view to interact with the Machine XML file. Using this view, the user can drag and drop select objects according to a desired computing architecture. For example, a user can drag and drop machines, dependencies, sequences, packages, groups, etc. using this view.

Alternatively, at 214 the user can opt to use a “tree view” to interact with the Machine XML file. Using the tree view, the user can add and remove nodes, such as machines, dependencies, sequences, packages, groups, etc. for example. In one embodiment, the managing application can be configured to switch from the drag and drop view to the tree view by clicking a button, using CTRL and an associated key, macro, etc. In the views described above, available machines, packages, etc. can be graphically presented to an authorized user for use in creating and or edited a deployment blueprint. Other views and interactive presentations are available and the embodiments and examples described herein are not intended to be limiting.

Once a user has elected a preferred view, the flow proceeds to 216 and the user has a number of available options to select from which can result in the creation or generation of a deployment blueprint in the form of a Machine XML file. In one embodiment, the number of available options corresponds with the creation or generation of a number of application programming interface (API) functions. Correspondingly, the API functions can be encapsulated in a dll that can be installed on (or included as part of) a computing device, wherein a number of applications, including hosted applications, can consume the associated functions of the dll.

As shown in FIG. 2, the user has a number of available API functions to select from which include, but are not limited to: Add Machine; Remove Machine; Add Dependency; Remove Dependency; Add to Sequence; Remove from Sequence; Add include File; Remove include File; Add Group; Remove Group; Update Machine; Update Package; Add Package Dependency; Remove Package Dependency; Delete Package; Delete Include; Add Group Genre; Delete Group Genre; Update Group Genre; Add Group Wire; Update Group Wire; and, Delete Group Wire; etc.

Using the managing application, the user can select from one or more of the available API functions which can be presented to the user based on the selected view. Once the user has selected one or more API functions for the deployment file, the flow proceeds to 218 and the number of selected API functions and other user actions are designated and saved to an associated Machine XML file. The Machine XML file can be stored locally or remotely for future use.

At 220, the Machine XML file can be validated against an associated validation schema. As part of the validation process, the Machine XML file can also be checked for other errors and inconsistencies. For example, a number of validation scenarios can include: validating to determine if string values are compatible with prescribed formats; validating schema compatibility (e.g., determine if defined machine XML is compatible with defined XML schema); and, validating to determine existence of packages (e.g., can be defined by path to package). An example of a validating schema is described further below.

If the Machine XML file passes the validation process, the flow proceeds to 222 and the Machine XML file can be checked-in for use in deploying the parameters and functions associated therewith and the flow ends at 224. If the Machine XML file does not pass the validation process, the flow proceeds to 226 and, if enabled, the managing application can apply an autocorrect process. If the autocorrect process is disabled, the flow returns to 216 and the managing application can operate to present a number of issues associated with the validation process to the user.

For either situation, a user does not have to wait for a deployment to begin to determine if there are issues with a deployment blueprint. Thus, the above-described deployment process provides a preemptive solution which can ultimately save users time and reduce issues when deploying a computing architecture. As an example, the managing application can operate to suggest a number of corrective actions that a user can take to overcome one or more issues. The user can then use a suggested action for a validation issue. Once the user is satisfied with ant changes, including any corrections, the flow again proceeds to 218 as described above. On the other hand, if the autocorrect process is enabled, the managing application can operate to automatically correct any issues associated with the validation process and pass the changes on and repeat validation at 220.

In an embodiment, the API functions described above can be exposed using a public class of a dll (e.g., machinexml.dll). A dll can be consumed by the managing application (e.g., as a UI) to present user-readable machine XML to perform various actions. A number of functions related to deployment can be leveraged using a machine XML object model. In one embodiment, a number of functions can be created or generated by the managing application using an object model as follows:

Object: MachineXML

For example create object Machine of machinexml.dll as MXM:

Object MXM=new machinexml.xml

The open function (e.g., MXM.open) can be used to open any existing machine.xml files. A user may pass a local path, universal naming convention (UNC) path, or other designated path.

The validation function (e.g., MXM.validation) operates to conform an XML file with a defined schema. For example, the validation function can be used to ensure that machine XML files conform to a defined schema. In one embodiment, the function returns a true indication if the file conforms with the defined schema; otherwise, the function operates to return a false indication and associated details. The validation function can be used in a variety of scenarios. For example, the validation function can be used to: validate whether string values are compatible with prescribed formats; validate schema compatibility, such as whether a deployment file is compatible with a defined schema; and, validate the existence of certain packages.

The update function (e.g., MXM.update) this function allows a user to save updated machine XML files, including validated files. In one embodiment, the update function uses the machine path as a string parameter with an option to replace file or create a new file.

Object: Machine

For example, create object Machine of machinexml.dll as MXM.

The add function (e.g., Mxm.machine.add) enables users or parent applications to add a machine to a machine XML file. Users can create a machine XML object and assign a machine XML file thereto before calling this function; otherwise, the function may result in error. In one embodiment, the managing application is configured to pass the following parameters for this function:
i. Override function
ii. Parameters: machinename, group, sequence, order
iii. Parameters: accountname, domain, user
iv. Parameters: Installpackage, flavor

The update function (e.g., Mxm.machine.update) enables users or parent applications to update existing machine information for an associated machine XML file. Users can create a machine XML object and assign a machine XML file thereto before calling this function; otherwise, the function may result in error. In one embodiment, the managing application is configured to pass the following parameters for this function:
i. Override function
ii. Parameters: machinename, group, sequence, order
iii. Parameters: accountname, domain, user
iv. Parameters: Installpackage, flavor

The delete function (e.g., Mxm.machine.delete) enables users or parent applications to delete a machine from an associated machine XML file. Users can create a machine XML object and assign a machine XML file thereto before calling this function; otherwise, the function may result in error. In one embodiment, the managing application is configured to pass the following parameter for this function:
i. Parameter: machinename

An example of a corresponding output is as follows:

```
    <Machine Name=“TK2OFFWB237” Group=“RTM”>
      <Account  Name=“office.aws.default.user” Domain=“PHX”
User=“_oapppool” />
      <Install Package=“office.ipo.aws” Flavor=“ship” />
    </Machine>
```

Object: Package

For example, create object Machine of machinexml.dll as MXM.

The add function (e.g., Mxm.package.add) enables users or parent applications to add a package to an associated machine. In one embodiment, any dependency packages should be added before adding a main package. As described below, once a dependency package is added, a dependency function can be used to update the dependency package. Users can create a machine XML object and assign a machine XML file thereto before calling this function; otherwise, the function may result in error. In one embodiment, the managing application is configured to pass the following parameters for this function:
i. Parameters: machinename, name, flavor, version

The update function (e.g., Mxm.package.update) enables users or parent applications to update a package of an associated machine. In one embodiment, any dependency packages should be added before adding a main package. As described below, once a dependency package is added, a dependency function can be used to update the dependency package. Users can create a machine XML object and assign a machine XML file thereto before calling this function; otherwise, the function may result in error. In one embodiment, the managing application is configured to pass the following parameters for this function:
i. Parameters: machinename, name, flavor, version

The dependency function (e.g., Mxm.package.dependency) enables users or parent applications to update a dependency in a package of an associated machine. Users can create a machine XML object and assign a machine XML file thereto before calling this function; otherwise, the function may result in error. In one embodiment, the managing application is configured to pass the following parameters for this function:
i. Parameters: parentname, name, flavor, version

The remove dependency function (e.g., Mxm.package.removedependency) enables users or parent applications to remove a dependency in a package of an associated machine. Users can create a machine XML object and assign a machine XML file thereto before calling this function; otherwise, the function may result in error. In one embodiment, the managing application is configured to pass the following parameters for this function:
i. Parameters: machinename, parentname, name, flavor, version

The delete function (e.g., Mxm.package.delete) enables users or parent applications to delete a package of an associated machine. In an embodiment, one or more dependency packages are automatically deleted once an associated parent package is dropped. Users can create a machine XML object and assign a machine XML file thereto before calling this function; otherwise, the function may result in error. In one embodiment, the managing application is configured to pass the following parameters for this function:
i. Parameters: machinename, name

An example of a corresponding output is as follows:

```
  <Package Name=“office.ipo.ULSReport” Flavor=“ship” Version=“1”>
    <Dependency Package=“jukebox.wires” />
    <Dependency  Package=“office.ipo.ulsreport” Flavor=“ship”
Language=“1033” />
  </Package>
```

Object: Include

For example, create object Machine of machinexml.dll as MXM.

The add function (e.g., Mxm.include.add) enables users or parent applications to add an include path to a machine XML file. The function can be called in conjunction with machine XML file update functions. The include path can then be incorporated into the resultant machine XML file. In one embodiment, when the machine XML file is consumed for deployment, an include path is expanded in a main XML file which contains all such includes and machine XML files. In one embodiment, the main XML file is the source file for a deployment engine. Users can create a machine XML object and assign a machine XML file thereto before calling this function; otherwise, the function may result in error. In one embodiment, the managing application is configured to pass the following parameter for this function:
i. Parameters: path

The update function (e.g., Mxm.include.update) this function enables users or parent applications to update an include path to a machine XML file. The function can be called in conjunction with machine XML file update functions. The include path can then be incorporated into the resultant machine XML file. In one embodiment, when the machine XML file is consumed for deployment, an include path is expanded in a main XML file which contains all such includes and machine XML files. The main XML file is the source file for a deployment engine. Users can create a machine XML object and assign a machine XML file thereto before calling this function; otherwise, the function may result in error. In one embodiment, the managing application is configured to pass the following parameter for this function:
i. Parameters: path

The delete function (e.g., Mxm.include.delete) enables users or parent applications to delete an include path from a machine XML file. Users can create a machine XML object and assign a machine XML file thereto before calling this function; otherwise, the function may result in error. In one embodiment, the managing application is configured to pass the following parameter for this function:
i. Parameters: path

Object: Group

The group object provides for the grouping of machines from a configuration perspective. In one embodiment, a configuration applied to a group will be applied to all the machines associated with the group.

For example, create object Machine of machinexml.dll as MXM.

The add function (e.g., Mxm.group.add) enables users or parent applications to add a group to a machine XML file. Users can create a machine XML object and assign a machine XML file thereto before calling this function; otherwise, the function may result in error. In one embodiment, the managing application is configured to pass the following parameter for this function:
i. Parameters: name

The update function (e.g., Mxm.group.update) enables users or parent applications to update a group of an existing or new machine XML file. Users can create a machine XML object and assign a machine XML file thereto before calling this function; otherwise, the function may result in error. In one embodiment, the managing application is configured to pass the following parameters for this function:
i. Parameters: oldname, newname

The delete function (e.g., Mxm.group.delete) enables users or parent applications to delete a group from a machine XML file. Users can create a machine XML object and assign a machine XML file thereto before calling this function; otherwise, the function may result in error. In one embodiment, the managing application is configured to pass the following parameter for this function:
i. Parameters: name

The add function (e.g., Mxm.group.genre.add) enables users or parent applications to add a genre that is to be associated with one or more machines. The genre can be described as an indexed array of records which hold data. Records can be provided in a package to provide default values. A genre is a configuration item that may be applied on multiple machines. In an embodiment, the genre can be stored in a registry and surfaced using a number of APIs, such as Jukebox APIs for example. Users can create a machine XML object and assign a machine XML file thereto, followed by a genre object for an associated group before calling this function; otherwise, the function may result in error. In one embodiment, the managing application is configured to pass the following parameters for this function:
i. Parameters: genrename, recordtype

The update function (e.g., Mxm.group.genre.update) enables users or parent applications to update a genre that is associated with one or more machines. Users can create a machine XML object and assign a machine XML file thereto, followed by a genre object for an associated group before calling this function; otherwise, the function may result in error. In one embodiment, the managing application is configured to pass the following parameters for this function:
i. Parameters: genrename, recordtype

The remove function (e.g., Mxm.group.genre.remove) enables users or parent applications to delete a genre that is associated with one or more machines. Users can create a machine XML object and assign a machine XML file thereto, followed by a genre object for an associated group before calling this function; otherwise, the function may result in error. In one embodiment, the managing application is configured to pass the following parameter for this function:
i. Parameters: genrename

When instantiating, the associated records can be given Index attributes (unless explicitly provided) and default values from the package are provided for any values not given at the Machine or Group levels. In one embodiment, genres that are explicitly declared for a package are copied from a Group declaration.

The example below illustrates the use of genres:

```
<Package Name=“logging” Language=“1033” Version=“11.0.3814.0”>
  <Genre Name=“levels”/>
  <Genre Name=“DomainName”>
      <Record Type=“string”>localhost</Record>
  </Genre>
  <Genre Name=“verbose”>
      <Record Type=“int”>0</Record
  </Genre>
</Package>
<Group Name=“delivery”>
  <Genre Name=“levels”>
      <Record Type=“int”>99</Record>
      <Record Type=“int”>0</Record>
      <Record Type=“int”>1</Record>
  </Genre>
</Group>
<Machine Name=“delivery1” Group=“delivery”>
  <Install Package=“logging” Language=“1033”/>
  <Genre Name=“DomainName”>
      <Record Type=“string”>www.office.net</Record>
  </Genre>
</Machine>
Gets instantiated like so:
<Machine Name=“delivery1” Group=“delivery”>
  <Install Package=“logging” Language=“1033”
  Version=“11.0.3814.0”/>
  <Genre Name=“levels”>
      <Record Index=“0” Type=“int”>99</Record>
      <Record Index=“1” Type=“int”>0</Record>
      <Record Index=“2” Type=“int”>1</Record>
  </Genre>
  <Genre Name=“DomainName”>
      <Record Index=“0” Type=“string”>www.office.net</Record>
  </Genre>
  <Genre Name=“verbose”>
      <Record Type=“int”>0</Record>
  </Genre>
</Machine>
```

In the above example, records in the “levels” genre are taken from the “delivery” group. The “DomainName” record was defined at the Machine level and overrides a default given in the package, and the “verbose” record assumed the default specified in the package.

The add function (e.g., Mxm.group.wire.add) function enables users or parent applications to create a new wire or connection string information associated with a component, such as a backend component for example, of an associated machine XML file. In one embodiment, the connection string information can be stored in a registry and surfaced using a number of APIs, such as Jukebox APIs for example. Users can create a machine XML object and assign a machine XML file thereto, followed by a wire object for an associated group before calling this function; otherwise, the function may result in error. In one embodiment, the managing application is configured to pass the following parameters for this function:
i. Parameters: name, recordtype

The update function (e.g., Mxm.group.wire.update) enables users or parent applications to update an existing wire or connection string information associated with a component of an associated machine XML file. Users can create a machine XML object and assign a machine XML file thereto, followed by a wire object for an associated group before calling this function; otherwise, the function may result in error. In one embodiment, the managing application is configured to pass the following parameters for this function:
i. Parameters: name, recordtype

The remove function (e.g., Mxm.group.wire.remove) enables users or parent applications to remove an existing wire or connection string information associated with a component of an associated machine XML file. Users can create a machine XML object and assign a machine XML file thereto, followed by a wire object for an associated group before calling this function; otherwise, the function may result in error. In one embodiment, the managing application is configured to pass the following parameters for this function:
i. Parameters: name, recordtype

Ports and wires can be referred to as connection strings which can be set at runtime (through Jukebox for example). For example, the settings can be accessed through the Jukebox as incoming ports include an indexed array of wires including connection strings to other machines.

Ports are similar to genres. Ports can be indexed, can include default values defined in the package; and can be specified at the Machine or Group level. Ports differ from genres in that they have additional attributes, including Protocol, Server, External, and Postfix attributes. Correspondingly, attributes can be used to generate content intelligently.

In one embodiment, any given port is either a client or a server of a protocol. When server ports are instantiated, they get populated with a connection element that contains the connection string by which clients access that port. These strings can be built according to the Protocol attribute (see Table below) and a machine name, wherein the Postfix attribute can be appended to the text.

TABLE

| Protocol | Connection String |
|---|---|
| smb | \\machine\postfix |
| http | http://machine/postfix |
| tds | SERVER=machine;postfix |

For example, suppose a database is as follows:

```
<Package Name=“backend” Version=“11.0.3811.0”>
  <Port Name=“backend.sql” Protocol=“tds” Server=“yes” External=“no”
      Postfix=“DATABASE=be”/>
</Package>
<Machine Name=“delivery1” Group=“delivery”>
  <Install Name=“backend” Version=“11.0.3811.0”/>
</Machine>
Gets instantiated to this:
<Machine Name=“delivery1” Group=“delivery”>
  <Install Name=“backend” Version=“11.0.3811.0”/>
  <Port Name=“backend.sql” Protocol=“tds” Server=“yes” External=“no”
      Postfix=“DATABASE=backend”/>
<Connection>SERVER=delivery1;DATABASE=backend</Connection>
  </Port>
</Machine>
```

The Connection element can be used internally for the next part of the process, in which client ports can be instantiated and wired-up to server ports. In one embodiment, when a client port is instantiated, the Wire elements can be resolved into connection strings according to following rules:

1. If the Wire element has text, use that string directly.

2. If the ServerPort attribute is omitted, assume it has the same Name as the client Port.

3. If the Server attribute is omitted, search machines in the Group hierarchy for the given ServerPort.

The above logic is illustrated by adding the following data to the above example:

```
<Package Name=“frontend” Language=“1033” Version=“11.0.3811.0”>
  <Port Name=“backend.unc” Protocol=“smb” Server=“no”>
      <Wire>\\products\public\products</Wire>
  </Port>
  <Port Name=“backend.sql” Protocol=“tds” Server=“no”/>
</Package>
<Group Name=“delivery”>
  <Port Name=“backend.unc”>
      <Wire>\\delivery\public\store</Wire>
  </Port>
</Group>
<Machine Name=“delivery2” Group=“delivery”>
  <Install Name=“frontend” Language=“1033” Version=“11.0.3811.0”/>
  <Port Name=“backend.sql”>
      <Wire/>
  </Port>
</Machine>
```

The “delivery2” machine gets instantiated to this:

```
<Machine Name=“delivery2” Group=“delivery”>
    <Port Name=“backend.unc” Protocol=“smb” Server=“no”>
        <Wire Index=“0”>\\delivery\public\store</Wire>
    </Port>
    <Install Name=“frontend” Language=“1033”
    Version=“11.0.3811.0”/>
    <Port Name=“backend.sql” Protocol=“tds” Server=“no”>
        <Wire Index=“0” Server=“delivery1”>
            SERVER=delivery1;DATABASE=backend</Wire>
    </Port>
</Machine>
```

The “backend.unc” port inherited its connection string from the setting in the “delivery” Group. Without that setting, it can inherit the default string provided in the package data. The “backend.sq1” port was matched to the server port on “delivery1” and the connection dropped into the Wire element.

In one embodiment, a wiring algorithm can first search in the current Group. If no matches are found, the algorithm can search for a match in the hierarchy, including all matches at an associated depth.

Ports can be placed at the Machine or Group levels. Ports placed at the Group level are inherited by Machines with Packages that include those Ports. In that inheritance, any Wire elements inside the Group can be inherited as well.

Wire elements can also be placed outside of Ports, directly beneath a Machine or Group element. In the Machine case, the Wire applies to all Ports instantiated on that Machine. In the Group case, the Wire applies to all Ports instantiated on all Machines in the Group. An empty wire in the global group, shown in the example below, causes wires to be inferred for all ports.

<Group>
<Wire/>
</Group>

Other objects and associated parameters are available.

According to one embodiment, the following schema can be used to present a number of deployment parameters and/or options to a user when defining a deployment blueprint for an associated purpose. For example, the manager component 102 can use the schema when presenting deployment options to a user. As further example, the manager component 102 can include the schema for use in validating a deployment blueprint (e.g., Machine XML files). The schema can include the following, but is not so limited:

A number of examples described below illustrate using the manager component 102 with a deployment blueprint file, such as an XML-based deployment file.

### EXAMPLE 1

Richard, a tester, wants to add a couple of computing devices to his test cluster TC2. The computing devices have been prepped and are ready for deployment. He launches the manager component 102 and opens the XML-based deployment file for TC2. After opening the deployment file for TC2, Richard adds computing device IPOIWTST1 and computing device IPOIWTST2, and also designates the associated packages to be installed on each computing device. The manager component 102 updates the deployment file for TC2 with the associated modification. When deployment begins, computing device IPOIWTST1 and computing device IPOIWTST2 will receive new bits and configured roles based on the information contained in the modified deployment file for TC2.

### EXAMPLE 2

Julia would like to add a new eight box cluster for an online service package. She launches the manager component 102 and adds eight boxes using the associated setup wizard. Thereafter, Julia creates a machine mapping package, a dependency mapping package, defines installation sequencing, and defines installation dependency. Thereafter, Julie clicks “Create” and a “browser create and save file” dialogue map appears that allows her to save the deployment blueprint as an XML-based deployment file (e.g., machine.xml).

### EXAMPLE 3

Peter has just updated a production machine XML (Prod.xml) file to add a couple of new packages. He launches the manager component 102, opens the Prod.xml file and clicks a “Validate” button of the user interface. Thereafter, the manager component 102 returns a validation message that an attribute is missing from one of the machine tags, including the pertinent information so that Peter can correct the issue. Armed with the knowledge of the validation issue, Peter uses the manager component 102 to edit the Prod.xml file and makes the appropriate change. Peter clicks the “Validate” button again and the manager component 102 returns a validation message of no errors. Once validated, Peter is ready for deployment using the validated Prod.xml file for his blueprint.

Embodiments described herein can be used when defining a blueprint associated with the deployment of a number of computing devices. Various embodiments provide a quick and efficient way to define a blueprint associated with a computing architecture. For example, a user can define a blueprint for a cluster of servers, wherein the cluster can be deployed according to the defined blueprint. A user can define a blueprint which then can be used to deploy computing devices for testing code and programs, debugging code and programs, and/or performing other configuration, testing, and computing operations. For example, a number of computing devices can be deployed according to a defined blueprint, including a defined operating system (OS), defined middleware, and/or defined test bits in accordance with particular deployment parameters.

### Exemplary Operating Environment

Referring now to FIG. 3, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 3, an illustrative operating environment for embodiments of the invention will be described. As shown in FIG. 3, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 32, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 32 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as a managing application 24, word processing application 28, a spreadsheet application 30, e-mail application 34, drawing application, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer readable medium including executable instructions which, when executed, manage aspects of a computing environment by:
defining a number of deployment parameters associated with a deployment blueprint, wherein the deployment parameters define a deployment configuration for a number of computing devices to be used in the computing environment;
defining a number of deployment functions associated with the number of deployment parameters, wherein the number of deployment functions can be called to deploy the number of computing devices to include the defined number of deployment parameters; and,
storing the number of deployment parameters and the number of associated deployment functions as a deployment file.

2. The computer-readable medium of claim 1, wherein the instructions, when executed, manage aspects of the computing environment by defining the deployment blueprint to correspond with a data center computing architecture.

3. The computer-readable medium of claim 1, wherein the instructions, when executed, manage aspects of the computing environment by storing the number of deployment parameters and associated deployment functions as an XML-based deployment file.

4. The computer-readable medium of claim 3, wherein the instructions, when executed, manage aspects of the computing environment by validating the XML-based deployment file against a defined schema.

5. The computer-readable medium of claim 1, wherein the instructions, when executed, manage aspects of the computing environment by creating the number of deployment functions using an object model that comprises an object corresponding with an XML file.

6. The computer-readable medium of claim 5, wherein the instructions, when executed, manage aspects of the computing environment by creating the number of deployment functions using an XML file object including:
defining an open function to open an XML file;
defining a validation function to validate the XML file; or,
defining an update function to save an updated XML file.

7. The computer-readable medium of claim 1, wherein the instructions, when executed, manage aspects of the computing environment by creating the number of deployment functions using an object model that comprises an object corresponding with a machine.

8. The computer-readable medium of claim 7, wherein the instructions, when executed, manage aspects of the computing environment by creating the number of deployment functions using a machine object including:
defining an add function to add a machine to an XML file;
defining an update function to update an existing machine associated with the XML file; or,
defining a delete function to remove an existing machine from the XML file.

9. The computer-readable medium of claim 7, wherein the instructions, when executed, manage aspects of the computing environment by creating the number of deployment functions using the machine object to define a virtual machine or a logical machine.

10. The computer-readable medium of claim 1, wherein the instructions, when executed, manage aspects of the computing environment by creating the number of deployment functions using an object model that comprises an object corresponding with a package to be associated with a machine.

11. The computer-readable medium of claim 10, wherein the instructions, when executed, manage aspects of the computing environment by creating the number of deployment functions using a package object including:
defining an add function to add a package to an XML file;
defining an update function to update an existing package associated with the XML file;
defining a dependency function to update a dependency in a package associated with the XML file;
defining a remove dependency function to remove a dependency in a package associated with the XML file; or,
defining a delete function to delete an existing package associated with the XML file.

12. The computer-readable medium of claim 1, wherein the instructions, when executed, manage aspects of the computing environment by creating the number of deployment functions using an object model that comprises an include object corresponding with an include path to be associated with an XML file.

13. The computer-readable medium of claim 12, wherein the instructions, when executed, manage aspects of the computing environment by creating the number of deployment functions using an include object including:
defining an add function to add an include path to the XML file;
defining an update function to update an existing include path associated with the XML file; or,
defining a delete function to delete an existing include path associated with the XML file.

14. The computer-readable medium of claim 1, wherein the instructions, when executed, manage aspects of the computing environment by creating the number of deployment functions using an object model that comprises an object corresponding with a group to be associated with an XML file.

15. The computer-readable medium of claim 14, wherein the instructions, when executed, manage aspects of the computing environment by creating the number of deployment functions using a group object including:
defining an add function to add a group to the XML file;
defining an update function to update an existing group associated with the XML file; or,
defining a delete function to delete an existing group associated with the XML file.

16. A manager component used to define a deployment configuration, the manager component being configured to:
define a number of deployment parameters associated with a number of computing devices to be deployed as part of a computing architecture;
generate a number of deployment functions associated with the deployment parameters, including using an object model to generate the number of deployment functions, wherein the object model comprises an XML file object, a machine object, and a package object; and,
store the number of deployment functions associated with the deployment parameters as part of a deployment file.

17. The system of claim 16, wherein manager component is further configured to generate the number of deployment functions associated with the deployment parameters, including using the object model to generate the number of deployment functions, wherein the object model further comprises an include object and a group object.

18. A method of configuring a deployment comprising:
receiving a number of deployment parameters based in part on a number of available deployment options, wherein the deployment parameters are associated with a deployment configuration of a computing architecture;
generating a number of deployment functions based in part on the number of deployment parameters, wherein the number of deployment functions are used when deploying the computing architecture;
creating an XML-based deployment file to include the number of deployment functions; and,
validating the XML-based deployment file using a defined schema.

19. The method of claim 18, further comprising transitioning the XML-based deployment file to an SML-based deployment file.

20. The method of claim 18, further comprising automatically correcting an invalid XML-based deployment file.
